(19) United States
(12) Patent Application Publication
(10) Pub. No.: US 2026/0070379 A1
(43) Pub. Date: Mar. 12, 2026

(54) AUTOMATIC TIRE CHANGER AND CONTROL SYSTEM FOR THE SAME

(71) Applicant: Shanghai Balance Automotive Equipment Co, Ltd., Shanghai (CN)

(72) Inventors: Xilin Cai, Shanghai (CN); Shaojie Feng, Shanghai (CN); Mingwen Ma, Shanghai (CN)

(21) Appl. No.: 18/829,334

(22) Filed: Sep. 10, 2024

(51) Int. Cl. B60C 25/05

(52) U.S. Cl. CPC B60C 25/0515; B60C 25/0536; B60C 25/0548

(57) ABSTRACT

Provided is an automatic tire changer, relating to the technical field of tire repair and maintenance. The automatic tire changer includes a base configured to carry a carrier of a device; a column vertically disposed on the base; a tire mounting seat mechanism movably disposed on the base and configured to secure a rim when a tire is demounted or mounted; a first demounting and mounting apparatus movably disposed on the column and configured to demount or mount an upper portion of the tire; a second demounting and mounting apparatus movably disposed on the column and configured to demount or mount a lower portion of the tire; and a control system configured to run a program and control multiple components to run through an execution mechanism.

### TECHNICAL FIELD

The present disclosure relates to the technical field of tire repair and maintenance and, in particular, to an automatic tire changer and a control system for the same.

### BACKGROUND

As the vehicle population has been increasing year by year, repair and maintenance and maintenance instead of repair have been also increasingly valued by people. In a tire repair and maintenance process, the cost and efficiency of tire demounting or mounting are increasingly valued. Although known tire changers have achieved some success in reducing the time and manpower of tire changing, there is still room for improvement, especially the need to increase the proportion of automatic operations and reduce manual operations in a tire changing process. Currently, most tire demounting and mounting machines and even lever-less tire demounting and mounting machines work under the full manual control of those skilled. Due to changes in the tire industry, tires with larger diameters, tires with shorter sidewalls and tires with very hard sidewalls have bloomed. Modern tire maintenance through manual operations has become increasingly difficult, and some run-flat tires cannot be demounted by common tire changers. Therefore, machinery is required to replace more manual operations to meet the requirements of the tire demounting or mounting operations.

### SUMMARY

An object of the present disclosure is to provide an automatic tire changer to reduce the dependence on manual labor in tire demounting or mounting operations, reduce the labor intensity of operators during a tire demounting or mounting process and increase the proportion of automatic operations during the tire demounting or mounting process.

To solve the preceding problems, embodiments of the present disclosure provide the technical solutions below.

An automatic tire changer is provided. The automatic tire changer includes a base configured to carry a carrier of a device; a column vertically disposed on the base; a tire mounting seat mechanism movably disposed on the base and configured to secure a rim when a tire is demounted or mounted; a first demounting and mounting apparatus movably disposed on the column and configured to demount or mount an upper portion of the tire; a second demounting and mounting apparatus movably disposed on the column and configured to demount or mount a lower portion of the tire; and a control system configured to run a program and control a plurality of components to run through an execution mechanism, where the control system is capable of automatically controlling the tire mounting seat mechanism, the first demounting and mounting apparatus and a second demounting and mounting apparatus to run according to an input instruction, and a running process involves no manual intervention.

Further, the tire mounting seat mechanism includes a central shaft and a hydraulic motor configured to drive the central shaft to rotate, where a bottom of the central shaft is securely provided with a grating disk, and a counter circuit board is disposed to correspond to the grating disk and configured to collect rotation data of the grating disk and the central shaft.

Further, a shaft sleeve is rotatably sleeved outside the central shaft, an upper end of the central shaft is exposed outside the shaft sleeve and configured to load and position the rim, and a lower end of the shaft sleeve is hinged to the base through a rotation shaft.

Further, the automatic tire changer includes an oil hydraulic cylinder securely disposed on the base, where the lower end of the shaft sleeve is provided with a flipping connector and securely connected to the flipping connector, a power output rod of the oil hydraulic cylinder is hinged to the flipping connector, and the oil hydraulic cylinder is capable of driving the shaft sleeve and the central shaft to rotate around the rotation shaft in a vertical direction through extension and retraction of the power output rod.

Further, a rotation angle of the central shaft around the rotation shaft ranges from 0° to 120°.

Further, the first demounting and mounting apparatus includes a first cylinder and a first commutation rotation shaft, where an end portion of one end of the first commutation rotation shaft is evenly provided with an upper tire pressing wheel, a tire demounting hook and an upper tire mounting hook in a circumferential direction of the first commutation rotation shaft, another end of the first commutation rotation shaft is formed with a first rotation groove, a first positioning pin passes through an end portion of a piston rod of the first cylinder and is slidably disposed within the first rotation groove, and a linear extension and retraction motion of the piston rod of the first cylinder drives the first positioning pin to slide along the first rotation groove to drive the first commutation rotation shaft to rotate.

Further, a side of the upper tire mounting hook is provided with a tire mounting auxiliary wheel.

Further, the second demounting and mounting apparatus includes a second cylinder and a second commutation rotation shaft, where an end portion of one end of the second commutation rotation shaft is provided with a lower tire pressing wheel and a lower tire mounting hook in a circumferential direction of the second commutation rotation shaft, another end of the second commutation rotation shaft is formed with a second rotation groove, a second positioning pin passes through an end portion of a piston rod of the second cylinder and is slidably disposed within the second rotation groove, and a linear extension and retraction motion of the piston rod of the second cylinder drives the second positioning pin to slide along the second rotation groove to drive the second commutation rotation shaft to rotate.

Further, an end portion of a body of the first cylinder is securely provided with a hollow first hexagonal rod, where the first hexagonal rod is sleeved outside the first commutation rotation shaft with a clearance, and an end portion of the first positioning pin is slidably disposed within a first linear positioning groove of the first hexagonal rod; an end portion of the second cylinder is securely provided with a hollow second hexagonal rod, where the second hexagonal rod is sleeved outside the second commutation rotation shaft with a clearance, and an end portion of the second positioning pin is slidably disposed within a second linear positioning groove of the second hexagonal rod; the first cylinder is a three-position cylinder, a middle position of a stroke of the first cylinder is a start dead center, a dead center to which the piston rod extends is a top dead center, a dead center to which the piston rod retracts is a bottom dead center, when the piston rod of the first cylinder is at the start dead center, the upper tire pressing wheel is in a working position, when the piston rod of the first cylinder extends forward to the top dead center, the tire demounting hook is in a working position, and when the piston rod of the first cylinder retracts backward to the bottom dead center, the upper tire mounting hook is in a working position; and a dead center to which the piston rod of the second cylinder extends is a top dead center, a dead center to which the piston rod of the second cylinder retracts is a bottom dead center, when the piston rod of the second cylinder is at the bottom dead center, the lower tire mounting hook is in a working position, and when the piston rod of the second cylinder is at the top dead center, the lower tire pressing wheel is in a working position.

Further, a distance measurement apparatus is disposed between the column and the first demounting and mounting apparatus and configured to detect a displacement of the first demounting and mounting apparatus relative to the column.

Further, a distance measurement apparatus is disposed between the column and the second demounting and mounting apparatus and configured to detect a displacement of the second demounting and mounting apparatus relative to the column.

Further, the automatic tire changer includes a vertical rack securely disposed on the column, a horizontal rack disposed on the first demounting and mounting apparatus and a horizontal rack disposed on the second demounting and mounting apparatus, where the distance measurement apparatuses include vertical displacement potentiometers and horizontal displacement potentiometers respectively, where rear ends of first potentiometer shafts of the vertical displacement potentiometers are securely provided with first distance measurement gears engaging with the vertical rack respectively, and vertical movement distances of the first demounting and mounting apparatus and the second demounting and mounting apparatus are obtained through rotation data of the first distance measurement gears respectively; and rear ends of second potentiometer shafts of the horizontal displacement potentiometers are securely provided with second distance measurement gears engaging with the horizontal racks respectively, and horizontal movement distances of the first demounting and mounting apparatus and the second demounting and mounting apparatus are obtained through rotation data of the second distance measurement gears respectively.

Further, the control system includes an operation console, a central processing unit (CPU) and a display device that are interconnected, where the operation console is provided with a key or a joystick for inputting an instruction and capable of separately controlling the tire mounting seat mechanism, the first tire changing apparatus and the second tire changing apparatus to run through the key or the joystick.

Further, the display device is a touch screen and capable of inputting an operation instruction and displaying a running state of the device.

Further, the automatic tire changer includes a hydraulic separation shovel.

Further, the automatic tire changer includes an auxiliary tire pressing arm rotatably disposed on a top end of the column.

An embodiment of the present disclosure further provides a control system for an automatic tire changer. The control system includes a central processing unit (CPU) configured to receive data information, perform a comprehensive operation on the data information and send an instruction; an operation console electrically connected to the CPU and configured to control input of the instruction; and a display device configured to display a program being executed and a running state of a device, where the data information at least includes rotation angle data of a tire and displacement data of a first demounting and mounting apparatus and a second demounting and mounting apparatus in horizontal and vertical directions.

Further, the display device is a touch screen and capable of controlling the input of the instruction.

Further, the control system includes a counter circuit board configured to collect the rotation angle data of the tire and distance measurement apparatuses configured to collect the displacement data of the first demounting and mounting apparatus and the second demounting and mounting apparatus in the horizontal and vertical directions respectively, where the CPU is configured to comprehensively calculate the rotation angle data of the tire and the displacement data of the first demounting and mounting apparatus and the second demounting and mounting apparatus in the horizontal and vertical directions and issue corresponding action instructions to a tire mounting seat mechanism, the first demounting and mounting apparatus and the second demounting and mounting apparatus to automatically demount or mount the tire.

Further, the displacement data of the first demounting and mounting apparatus and the second demounting and mounting apparatus in the horizontal and vertical directions is measured by potentiometers respectively.

### BRIEF DESCRIPTION OF DRAWINGS

FIG. 1 is a view illustrating the perspective structure of an automatic tire changer according to an embodiment of the present disclosure.

FIG. 2 is a view illustrating the structure when an automatic tire changer performs a tire changing operation according to an embodiment of the present disclosure.

FIG. 3 is a view illustrating the structure when an upper tire pressing wheel of a first demounting and mounting apparatus presses against a tire according to an embodiment of the present disclosure.

FIG. 4 is a view illustrating the structure when a lower tire pressing wheel of a second demounting and mounting apparatus presses against a tire according to an embodiment of the present disclosure.

FIG. 5 is a view illustrating the partial structure of a tire mounting seat mechanism connected to a base according to an embodiment of the present disclosure.

FIG. 6 is a view illustrating the measurement structure of a rotation angle of a central shaft of a tire mounting seat mechanism according to an embodiment of the present disclosure.

FIG. 7 is a view illustrating the structure of a tire mounting seat mechanism and a base in a vertically connected state according to an embodiment of the present disclosure.

FIG. 8 is a view illustrating the structure when a tire mounting seat mechanism rotates relative to a base according to an embodiment of the present disclosure.

FIG. 9 is a view illustrating the structure of a first demounting and mounting apparatus according to an embodiment of the present disclosure.

FIG. 10 is a view illustrating the structure of a first commutation rotation shaft of a first demounting and mounting apparatus according to an embodiment of the present disclosure.

FIG. 11 is a view illustrating the structure of a second demounting and mounting apparatus according to an embodiment of the present disclosure.

FIG. 12 is a view illustrating the structure of a second commutation rotation shaft of a second demounting and mounting apparatus according to an embodiment of the present disclosure.

FIG. 13 is a view illustrating the structure of distance measurement apparatuses of an automatic tire changer according to an embodiment of the present disclosure.

FIG. 14 is a partial enlarged view of part A of FIG. 13.

FIG. 15 is a cross-section view of a second demounting and mounting apparatus according to an embodiment of the present disclosure.

FIG. 16 is a view illustrating the structure of a horizontal displacement potentiometer of a distance measurement apparatus according to an embodiment of the present disclosure.

FIG. 17 is a view illustrating the structure of a vertical displacement potentiometer of a distance measurement apparatus according to an embodiment of the present disclosure.

### REFERENCE LIST

1 base
   11 support ear
   2 control system
   21 operation console
   22 display device
   23 CPU
3 auxiliary tire pressing arm
4 column
41 vertical rack
5 first demounting and mounting apparatus
51 upper tire pressing wheel
52 tire demounting hook
53 upper tire mounting hook
54 tire mounting auxiliary wheel
55 first cylinder
56 first hexagonal rod
57 first positioning pin
58 first commutation rotation shaft
581 first rotation groove
59 first linear positioning groove
6 second demounting and mounting apparatus
61 lower tire pressing wheel
62 lower tire mounting hook
63 second cylinder
64 second hexagonal rod
65 second commutation rotation shaft
651 second rotation groove
66 second positioning pin
67 horizontal rack
68 second linear positioning groove
7 tire mounting seat mechanism
71 central shaft
72 hydraulic motor
73 shaft sleeve
74 rotation shaft
75 flipping connector
76 oil hydraulic cylinder
761 power output rod
77 grating disk
78 counter circuit board
79 support plate
791 limiting member
8 hydraulic separation shovel
9 Hydraulic Pump Station
10 tire
20 distance measurement apparatus
201 support frame
202 vertical displacement potentiometer
2021 first potentiometer shaft
203 first distance measurement gear
204 horizontal displacement potentiometer
2041 second potentiometer shaft
205 second distance measurement gear
206 protective housing

### DETAILED DESCRIPTION

It is to be noted that if there is a directional indication (such as up, down, left, right, front and back) involved in the embodiments of the present disclosure, the directional indication is used for only explaining the relative positional relationship and motion between components in a particular posture, and if the particular posture changes, the directional indication also accordingly changes.

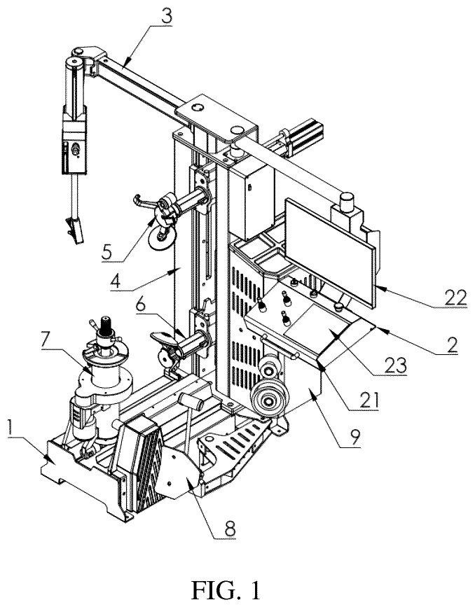

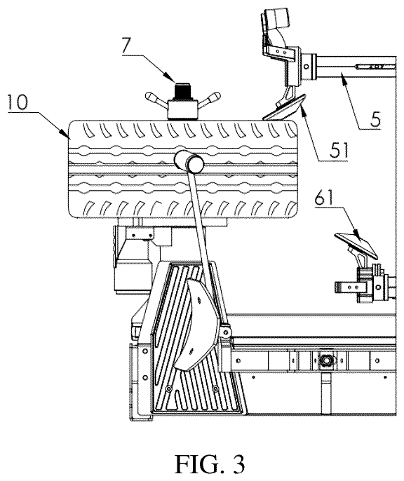

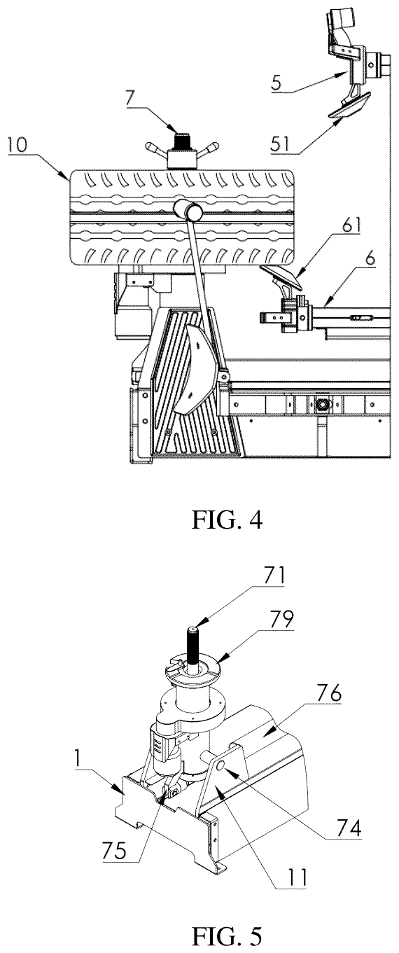

As shown in FIGS. 1 to 4, the present disclosure relates to an automatic tire changer. The automatic tire changer includes a base 1 configured to carry a carrier of a device; a column 4 vertically disposed on the base 1; a tire mounting seat mechanism 7 movably disposed on the base 1 and configured to secure a rim when a tire 10 is demounted or mounted; a first demounting and mounting apparatus 5 movably disposed on the column 4 and configured to demount or mount an upper portion of the tire 10; a second demounting and mounting apparatus 6 movably disposed on the column 4 and configured to demount or mount a lower portion of the tire 10; and a control system 2 configured to run a program and control multiple components to run through an execution mechanism, where the control system 2 can automatically control the tire mounting seat mechanism 7, a first tire changing apparatus and a second tire changing apparatus to run according to an input instruction, and the running process involves no manual intervention.

In an embodiment, the control system 2 includes an operation console 21, a central processing unit (CPU) 23, and a display device 22 that are interconnected. The operation console 21 is provided with a key or a joystick for inputting an instruction and can separately control the tire mounting seat mechanism 7, the first tire changing apparatus and the second tire changing apparatus to run through the key or the joystick. The display device 22 is a touch screen and can be configured to input an operation instruction and display the running state of the device. Preferably, the control system 2 is connected to the column 4 through a cantilever; one end of the cantilever is rotatably connected to the column 4, and the other end of the cantilever is securely connected to the control system 2; and the operation console 21 is provided with multiple keys, multiple knobs, or multiple joysticks for controlling devices of the automatic tire changer to run, facilitating the input of parameters for automatic demounting or mounting operations of the tire 10 or for operating the multiple keys, the multiple knobs or the multiple joysticks to control devices of the automatic tire changer in steps to run.

In an embodiment, the automatic tire changer further includes a Hydraulic Pump Station 9 configured as a power source of a hydraulic device of the automatic tire changer; and an upper end of the column 4 is rotatably provided with an auxiliary tire pressing arm 3 configured to press against the tire wall of the tire 10 when the tire 10 is demounted. The tire 10 is pressed at which the smallest rim diameter is provided to facilitate easy tire demounting. Similarly, the tire 10 is easy to mount when being mounted.

In an embodiment, to facilitate the quick loosening of the tire 10 by an operator to quickly separate the tire 10 from the rim, a side of the base 1 is provided with a hydraulic separation shovel 8; and the hydraulic separation shovel 8 is provided with a handle and uses hydraulic pressure as the power and thereby is suitable for loosening the tire 10 before automatic tire demounting.

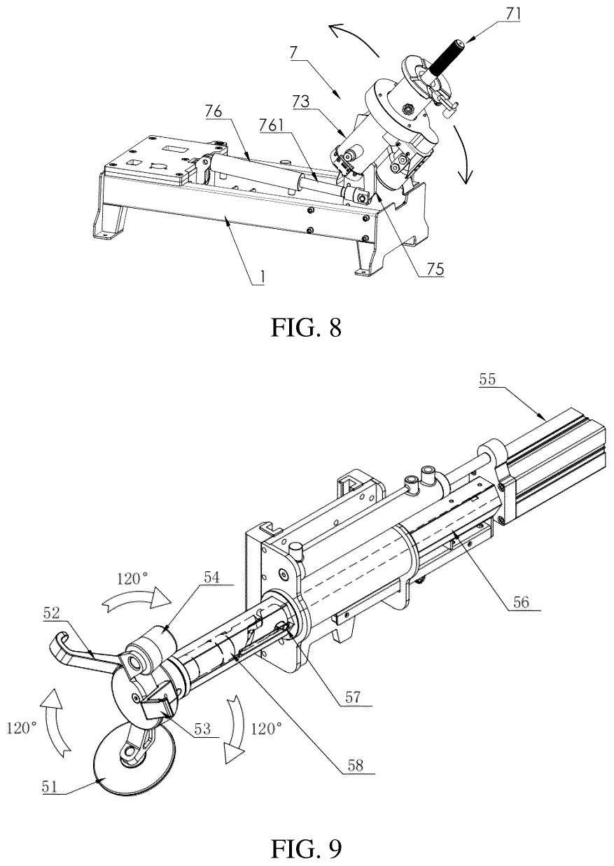

As shown in FIGS. 5 to 8, in an embodiment, the tire mounting seat mechanism 7 includes a central shaft 71 and a hydraulic motor 72 configured to drive the central shaft 71 to rotate; a shaft sleeve 73 is rotatably sleeved outside the central shaft 71, and an upper end of the central shaft 71 is exposed outside the shaft sleeve 73 and configured to load and position the rim; and a lower end of the shaft sleeve 73 is hinged to the base 1 through a rotation shaft 74. Specifically, the base 1 of the automatic tire changer is provided with a support ear 11 corresponding to an end portion of the shaft sleeve 73, and the rotation shaft 74 is rotatably connected to the support ear 11.

In an embodiment, the base 1 is provided with an oil hydraulic cylinder 76, the lower end of the shaft sleeve 73 is provided with a flipping connector 75 and securely connected to the flipping connector 75, a power output rod 761 of the oil hydraulic cylinder 76 is hinged to the flipping connector 75, the oil hydraulic cylinder 76 can drive the shaft sleeve 73 and the central shaft 71 to rotate around the rotation shaft 74 in a vertical direction through extension and retraction of the power output rod 761, and the rotation angle of the central shaft 71 around the rotation shaft 74 ranges from 0° to 120°. When the rotation angle of the central shaft 71 is 0°, the central shaft 71 is in the horizontal state, facilitating the mounting of the rim and the central shaft 71. In this case, the height of the central shaft 71 in the horizontal position corresponds to the height of a central hole of the rim when the tire 10 is vertically placed. After the rim is positioned on the central shaft 71, the oil hydraulic cylinder 76 is started to drive the shaft sleeve 73 and the central shaft 71 to rotate, and the central shaft 71 may stay at any angle from 0° to 120° to facilitate the demounting or mounting operations of the tire 10. Preferably, the rotation angle of the central shaft 71 is 90°, that is, the central shaft 71 is vertically disposed. The upper end of the central shaft 71 is securely provided with a support plate 79 configured to support the rim and maintain the stability of the rim. The support plate 79 is provided with a limiting member 791 configured to prevent the relative rotation between the rim and the support plate 79, that is, to maintain the synchronous rotation between the rim and the central shaft 71. To ensure the stability of the rim along an axis direction of the central shaft 71 in the demounted state, a top end of the central shaft 71 is provided with a thread. After the rim is positioned on the central shaft 71, a fastener is used for being sleeved at an end portion of the central shaft 71 and is rotated to tightly abut against and secure the rim to facilitate the automatic tire demounting or mounting operations.

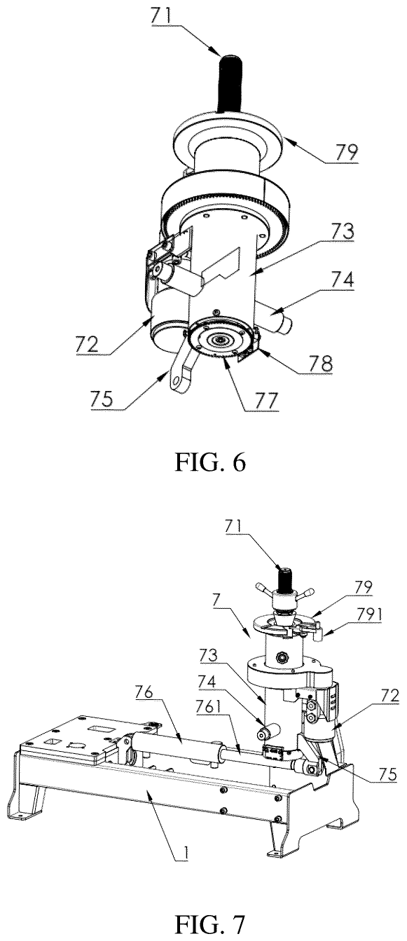

As shown in FIG. 6, the central shaft 71 is driven by the hydraulic motor 72, which has the characteristics of large torque and low noise but does not have a positioning function. The tire 10 is required for positioning during an automatic tire demounting or mounting process, especially for a tire 10 with a tire pressure sensor, where the position of the tire pressure sensor must be avoided to avoid damage to the tire pressure sensor. In an embodiment, the tire mounting seat mechanism 7 includes the central shaft 71 and the hydraulic motor 72 configured to drive the central shaft 71 to rotate, the bottom of the central shaft 71 is securely provided with a grating disk 77, and a counter circuit board 78 is disposed to correspond to the grating disk 77 and configured to collect rotation data of the grating disk 77 and the central shaft 71.

The bottom of the central shaft 71 is provided with the grating disk 77, and the shaft sleeve 73 is securely provided with the counter circuit board 78. The grating disk 77 may rotate with the central shaft 71, and the hydraulic motor 72 rotates the central shaft 71 through a gear, thereby driving the grating disk 77 to rotate. The counter circuit board 78 includes a phototube. The phototube is configured to sense a brightness change in light so that the resistance value of the phototube can change, thereby converting the brightness change in the light to a pulse signal to calculate the rotation displacement of the grating disk 77. The control system 2 performs a comprehensive operation by collecting data of the counter circuit board and data of a position sensor to avoid the position of the tire pressure sensor, thereby safely demounting or mounting the tire 10.

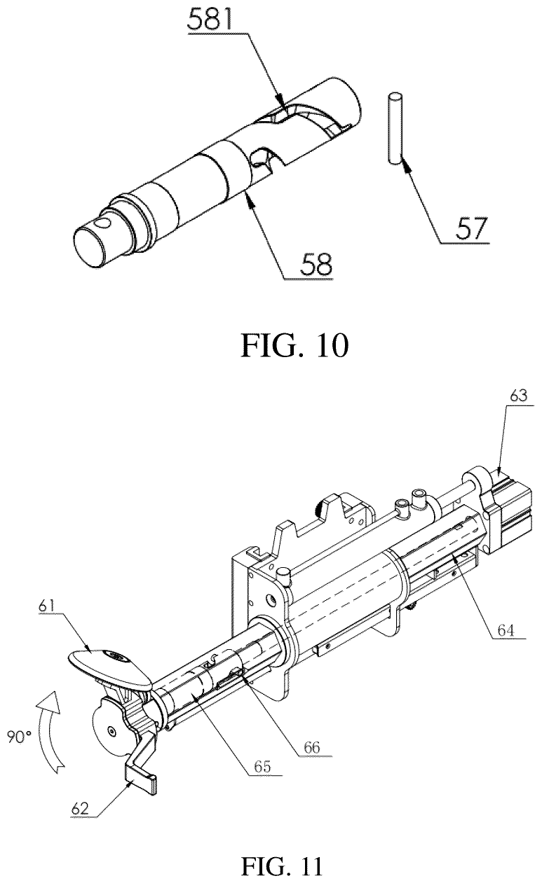

As shown in FIGS. 9 and 10, the present disclosure relates to an automatic tire changer, and the automatic tire changer includes the first demounting and mounting apparatus 5. The first demounting and mounting apparatus 5 includes a first cylinder 55 and a first commutation rotation shaft 58. An end portion of one end of the first commutation rotation shaft 58 is evenly provided with an upper tire pressing wheel 51, a tire demounting hook 52 and an upper tire mounting hook 53 in a circumferential direction of the first commutation rotation shaft 58, and the other end of the first commutation rotation shaft 58 is formed with a first rotation groove 581. A first positioning pin 57 passes through an end portion of a piston rod of the first cylinder 55 and is slidably disposed within the first rotation groove 581. A linear extension and retraction motion of the piston rod of the first cylinder 55 drives the first positioning pin 57 to slide along the first rotation groove 581 to drive the first commutation rotation shaft 58 to rotate. Preferably, a side of the upper tire mounting hook 53 is provided with a tire mounting auxiliary wheel 54. Specifically, the upper tire pressing wheel 51, the tire demounting hook 52 and the upper tire mounting hook 53 are each spaced 120° apart at the end portion of the first commutation rotation shaft 58, an end portion of a body of the first cylinder 55 is securely provided with a hollow first hexagonal rod 56, and the first hexagonal rod 56 is sleeved outside the first commutation rotation shaft 58 and the piston rod of the first cylinder 55 with a clearance; the first rotation groove 581 is formed within the first commutation rotation shaft 58, the first positioning pin 57 passes through the first rotation groove 581, and an end portion of the first positioning pin 57 is slidably disposed within a first linear positioning groove 59 of the first hexagonal rod 56; and the first cylinder 55 is a three-position cylinder, a middle position of the stroke of the first cylinder 55 is a start dead center, a final dead center to which the piston rod extends is a top dead center, a final dead center to which the piston rod retracts is a bottom dead center, when the piston rod of the first cylinder 55 is at the start dead center, the upper tire pressing wheel 51 is in a working position, when the piston rod of the first cylinder 55 extends forward to the top dead center, the tire demounting hook 52 is in a working position, and when the piston rod of the first cylinder 55 retracts backward to the bottom dead center, the upper tire mounting hook 53 is in a working position.

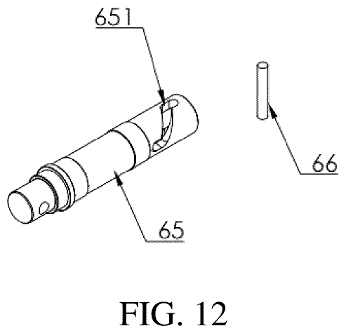

As shown in FIGS. 11 and 12, the present disclosure relates to an automatic tire changer, and the automatic tire changer includes the second demounting and mounting apparatus 6. The second demounting and mounting apparatus 6 includes a second cylinder 63 and a second commutation rotation shaft 65. An end portion of one end of the second commutation rotation shaft 65 is provided with a lower tire pressing wheel 61 and a lower tire mounting hook 62 in a circumferential direction of the second commutation rotation shaft 65. Preferably, the lower tire pressing wheel 61 and the lower tire mounting hook 62 are spaced 90° apart. The other end of the second commutation rotation shaft 65 is formed with a second rotation groove 651. A second positioning pin 66 passes through an end portion of a piston rod of the second cylinder 63 and is slidably disposed within the second rotation groove 651. A linear extension and retraction motion of the piston rod of the second cylinder 63 drives the second positioning pin 66 to slide along the second rotation groove 651 to drive the second commutation rotation shaft 65 to rotate. Specifically, an end portion of the second cylinder 63 is securely provided with a hollow second hexagonal rod 64, the second hexagonal rod 64 is sleeved outside the second commutation rotation shaft 65 with a clearance, and an end portion of the second positioning pin 66 is slidably disposed within a second linear positioning groove 68 of the second hexagonal rod 64; and a final dead center to which the piston rod of the second cylinder 63 extends is a top dead center, a final dead center to which the piston rod of the second cylinder 63 retracts is a bottom dead center, when the piston rod of the second cylinder 63 is at the bottom dead center, the lower tire mounting hook 62 is in a working position, and when the piston rod of the second cylinder 63 is at the top dead center, the lower tire pressing wheel 61 is in a working position.

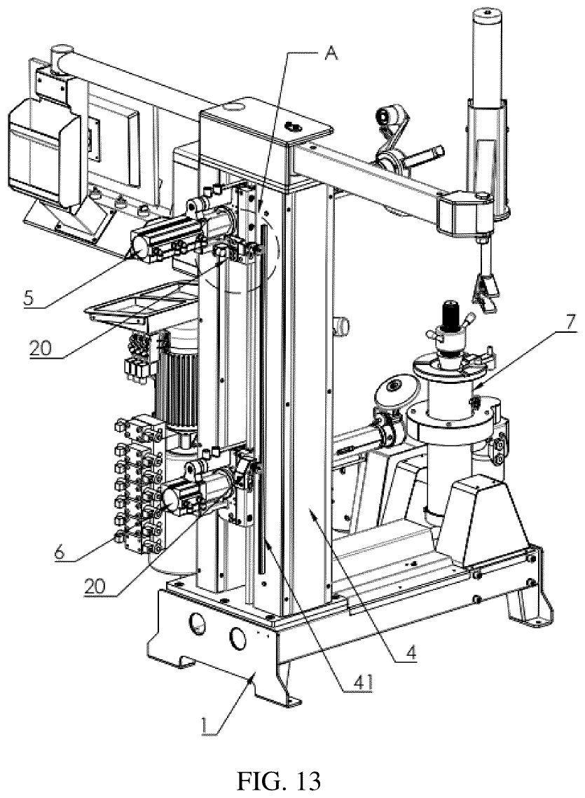

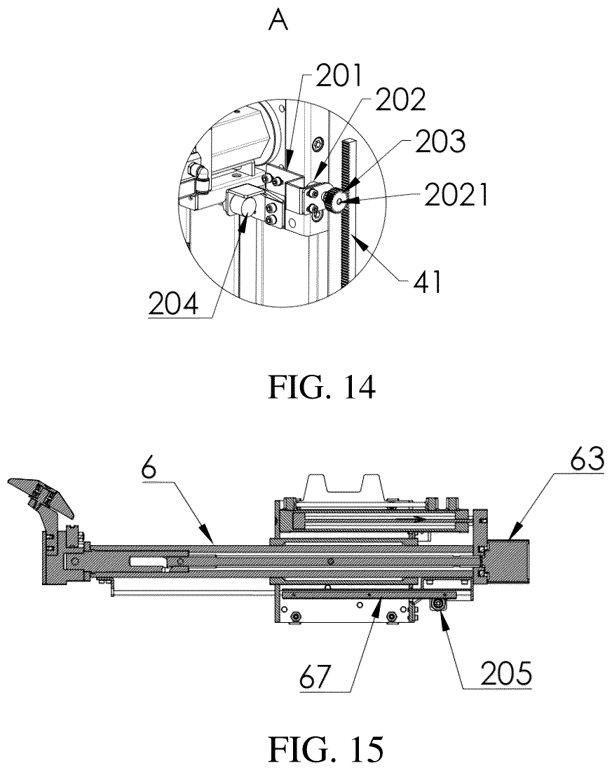

As shown in FIGS. 13 to 17, to detect and control running actions of the first demounting and mounting apparatus 5 and the second demounting and mounting apparatus 6, a distance measurement apparatus 20 is disposed between the column 4 and the first demounting and mounting apparatus 5 and configured to detect a horizontal displacement and a vertical displacement of the first demounting and mounting apparatus 5 relative to the column 4, and a distance measurement apparatus 20 is disposed between the column 4 and the second demounting and mounting apparatus 6 and configured to detect a horizontal displacement and a vertical displacement of the second demounting and mounting apparatus 6 relative to the column 4. Specifically, the column 4 is securely provided with a vertical rack 41 in a vertical direction of the column 4, and the distance measurement apparatuses 20 include vertical displacement potentiometers 202 and horizontal displacement potentiometers 204 respectively. The vertical displacement potentiometers 202 are securely connected to the horizontal displacement potentiometers 204 through support frames 201 respectively. Preferably, the support frames 201 are securely provided with protective housings 206 respectively to increase the tolerance of the vertical displacement potentiometers 202 and the horizontal displacement potentiometers 204 to environmental pollution, prolonging the service life of the vertical displacement potentiometers 202 and the horizontal displacement potentiometers 204.

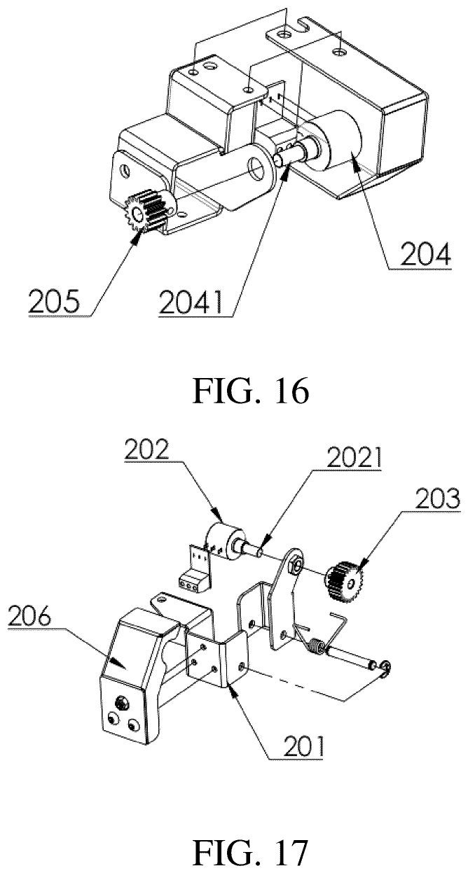

As shown in FIGS. 16 and 17, rear ends of first potentiometer shafts 2021 of the vertical displacement potentiometers 202 are securely provided with first distance measurement gears 203 engaging with the vertical rack 41 respectively, and vertical movement distances of the first demounting and mounting apparatus 5 and the second demounting and mounting apparatus 6 are obtained through rotation data of the first distance measurement gears 203 respectively; the first hexagonal rod 56 of the first demounting and mounting apparatus 5 is securely provided with a horizontal rack 67, a rear end of a second potentiometer shaft of a horizontal displacement potentiometer 204 is securely provided with a second distance measurement gear 205 engaging with the horizontal rack 67, and the horizontal movement distance of the first demounting and mounting apparatus 5 is obtained through rotation data of the second distance measurement gear 205; and the second hexagonal rod 64 of the second demounting and mounting apparatus 6 is securely provided with a horizontal rack 67, a rear end of a second potentiometer shaft of a horizontal displacement potentiometer 204 is securely provided with a second distance measurement gear 205 engaging with the horizontal rack 67, and the horizontal movement distance of the second demounting and mounting apparatus 6 is obtained through rotation data of the second distance measurement gear 205.

When the automatic tire changer provided in the present disclosure is used, the specific steps are included below.

In step one, a valve of the tire 10 is removed to completely deflate the tire 10, and after the tire 10 is completely deflated, the front and back sides of the tire 10 are loosened by the hydraulic separation shovel 8.

In step two, the tire mounting seat mechanism 7 is flipped down, and after the tire 10 is mounted, the tire mounting seat mechanism 7 is flipped to a horizontal position and locked.

In step three, after the tire 10 is secured, parameters of the tire 10 are input into the operation console 21, and a start key is pressed to perform a fully automatic tire demounting operation.

In step four, tire mounting steps are opposite to the tire demounting steps, and the lower portion of a tire is mounted before the upper portion of the tire.

The tire 10 may also be demounted or mounted by manually operating various buttons and joysticks to control various mechanisms according to the preceding steps.

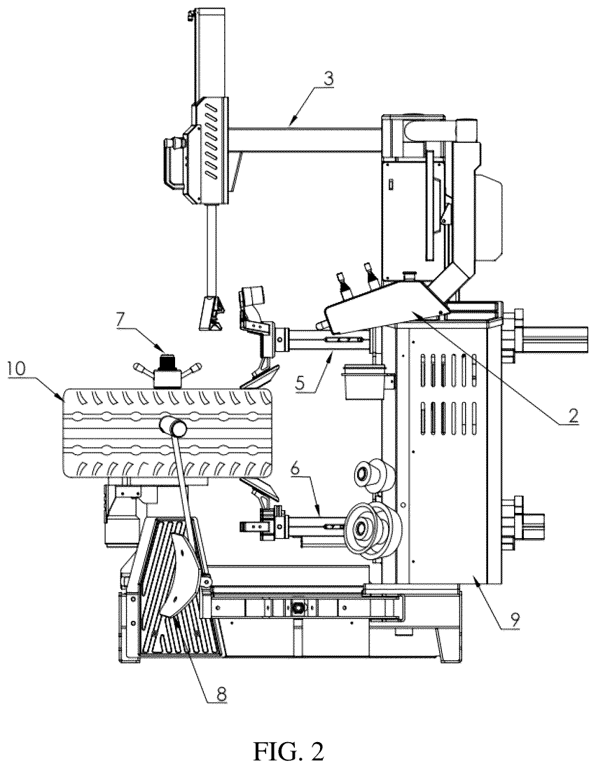

When an automatic tire demounting program is executed, as shown in FIGS. 2 to 4, the upper tire pressing wheel 51 performs an automatic tire pressing action according to an input diameter of the tire 10 and is automatically lifted upward after loosening an upper tire lip; the lower tire pressing wheel 61 is lifted upward to press against the lower portion of the tire 10; and when the upper tire lip and a lower tire lip are loosened, the tire demounting hook 52 is enabled to be in the working position by driving the first commutation rotation shaft 58 by the first cylinder 55 to rotate by 120° and performs a tire demounting action according to a preset program until the upper portion of the tire 10 is demounted. The entire process involves no manual intervention. The lower portion of the tire 10 is demounted by the lower tire pressing wheel 61.

When the tire 10 is mounted, the lower tire mounting hook 62 is enabled to be in the working position by driving the second commutation rotation shaft 65 by the second cylinder 63 to rotate by 90° and is automatically aligned to a tire mounting position by an execution mechanism to perform a lower tire mounting action. When the upper portion of the tire 10 is mounted, the upper tire mounting hook 53 is in the working position by an execution mechanism. When the upper tire mounting hook 53 performs a mounting action of the tire 10, the tire mounting auxiliary wheel 54 simultaneously presses against the tire lips to ensure that the tire lips of the tire 10 are lower than the surface of the rim and to protect the tire 10 from being damaged. Preferably, the auxiliary tire pressing arm 3 may also be simultaneously used for performing the upper tire mounting program.

The present disclosure further provides a control system 2 for an automatic tire changer. The control system 2 includes a CPU configured to receive data information, perform a comprehensive operation on the data information and send an instruction; an operation console 21 electrically connected to the CPU and configured to control the input of the instruction; and a display device 22 configured to display a program being executed and the running state of a device, where the data information at least includes rotation angle data of a tire 10 and displacement data of a first demounting and mounting apparatus 5 and a second demounting and mounting apparatus 6 in horizontal and vertical directions.

In a preferred embodiment, the control system 2 for an automatic tire changer further includes a counter circuit board 78 configured to collect the rotation angle data of the tire 10 and transmit the rotation angle data to the CPU 23 and distance measurement apparatuses 20 configured to collect the displacement data of the first demounting and mounting apparatus 5 and the second demounting and mounting apparatus 6 in the horizontal and vertical directions respectively, where the displacement data of the first demounting and mounting apparatus 5 and the second demounting and mounting apparatus 6 in the horizontal and vertical directions are obtained by potentiometers respectively and transmitted to the CPU 23, and the CPU 23 comprehensively calculates the rotation angle data of the tire 10 and the displacement data of the first demounting and mounting apparatus 5 and the second demounting and mounting apparatus 6 in the horizontal and vertical directions and issues corresponding action instructions to a tire mounting seat mechanism 7, the first demounting and mounting apparatus 5 and the second demounting and mounting apparatus 6 to automatically demount or mount the tire 10. Preferably, the display device 22 is a touch screen and can be configured to control the input of the instruction.

Compared with the related art, the automatic tire changer and the control system for the same provided in the present disclosure have the advantages below.

During a tire demounting or mounting process, the degree of automation can be high, the degree of fatigue of operators can be effectively reduced, the efficiency of tire demounting or mounting can be improved, and the labor cost can be reduced. The arrangement of the distance measurement apparatuses and the counter circuit board can improve the control precision of the control system on execution components, reduce damage to the rim and the tire lips during the tire demounting or mounting process and prolong the service life of the tire. The first demounting and mounting apparatus and the second demounting and mounting apparatus that integrate with tire pressing, tire demounting and tire mounting can be implemented by the multi-stroke cylinders. This can have a compact structure, be stable and reliable, quickly switch demounting and mounting tools and improve the efficiency of tire demounting or mounting.

It is to be understood by those of ordinary skill in the art that the preceding embodiments are specific examples of implementation of the present disclosure, and in practical applications, various changes in form and details can be made without departing from the spirit and the scope of the present disclosure.

What is claimed is:

1. An automatic tire changer, comprising:
a base configured to carry a carrier of a device;
a column vertically disposed on the base;
a tire mounting seat mechanism movably disposed on the base and configured to secure a rim when a tire is demounted or mounted;
a first demounting and mounting apparatus movably disposed on the column and configured to demount or mount an upper portion of the tire;
a second demounting and mounting apparatus movably disposed on the column and configured to demount or mount a lower portion of the tire; and
a control system configured to run a program and control a plurality of components to run through an execution mechanism, wherein the control system is capable of automatically controlling the tire mounting seat mechanism, the first demounting and mounting apparatus and the second demounting and mounting apparatus to run according to an input instruction, and a running process involves no manual intervention.

2. The automatic tire changer according to claim 1, wherein the tire mounting seat mechanism comprises a central shaft and a hydraulic motor configured to drive the central shaft to rotate, wherein a bottom of the central shaft is securely provided with a grating disk, and a counter circuit board corresponds to the grating disk and is configured to collect rotation data of the grating disk and the central shaft.

3. The automatic tire changer according to claim 2, wherein a shaft sleeve is rotatably sleeved outside the central shaft, an upper end of the central shaft is exposed outside the shaft sleeve and configured to load and position the rim, and a lower end of the shaft sleeve is hinged to the base through a rotation shaft.

4. The automatic tire changer according to claim 3, further comprising an oil hydraulic cylinder securely disposed on the base, wherein the lower end of the shaft sleeve is provided with a flipping connector and securely connected to the flipping connector, a power output rod of the oil hydraulic cylinder is hinged to the flipping connector, and the oil hydraulic cylinder is capable of driving the shaft sleeve and the central shaft to rotate around the rotation shaft in a vertical direction through extension and retraction of the power output rod.

5. The automatic tire changer according to claim 4, wherein a rotation angle of the central shaft around the rotation shaft ranges from 0° to 120°.

6. The automatic tire changer according to claim 1, wherein the first demounting and mounting apparatus comprises a first cylinder and a first commutation rotation shaft, wherein an end portion of one end of the first commutation rotation shaft is evenly provided with an upper tire pressing wheel, a tire demounting hook and an upper tire mounting hook in a circumferential direction of the first commutation rotation shaft, another end of the first commutation rotation shaft is formed with a first rotation groove, a first positioning pin passes through an end portion of a piston rod of the first cylinder and is slidably disposed within the first rotation groove, and a linear extension and retraction motion of the piston rod of the first cylinder drives the first positioning pin to slide along the first rotation groove to drive the first commutation rotation shaft to rotate.

7. The automatic tire changer according to claim 6, wherein a side of the upper tire mounting hook is provided with a tire mounting auxiliary wheel.

8. The automatic tire changer according to claim 7, wherein the second demounting and mounting apparatus comprises a second cylinder and a second commutation rotation shaft,
wherein an end portion of one end of the second commutation rotation shaft is provided with a lower tire pressing wheel and a lower tire mounting hook in a circumferential direction of the second commutation rotation shaft, another end of the second commutation rotation shaft is formed with a second rotation groove, a second positioning pin passes through an end portion of a piston rod of the second cylinder and is slidably disposed within the second rotation groove, and a linear extension and contraction motion of the piston rod of the second cylinder drives the second positioning pin to slide along the second rotation groove to drive the second commutation rotation shaft to rotate.

9. The automatic tire changer according to claim 8, wherein an end portion of a body of the first cylinder is securely provided with a hollow first hexagonal rod,
wherein the first hexagonal rod is sleeved outside the first commutation rotation shaft with a clearance, and an end portion of the first positioning pin is slidably disposed within a first linear positioning groove of the first hexagonal rod; an end portion of the second cylinder is securely provided with a hollow second hexagonal rod,
the second hexagonal rod is sleeved outside the second commutation rotation shaft with a clearance, and an end portion of the second positioning pin is slidably disposed within a second linear positioning groove of the second hexagonal rod,
the first cylinder is a three-position cylinder, a middle position of a stroke of the first cylinder is a start dead center, a dead center to which the piston rod extends is a top dead center, a dead center to which the piston rod retracts is a bottom dead center, when the piston rod of the first cylinder is at the start dead center, the upper tire pressing wheel is in a working position, when the piston rod of the first cylinder extends forward to the top dead center, the tire demounting hook is in a working position, and when the piston rod of the first cylinder retracts backward to the bottom dead center, the upper tire mounting hook is in a working position; and a dead center to which the piston rod of the second cylinder extends is a top dead center, a dead center to which the piston rod of the second cylinder retracts is a bottom dead center, when the piston rod of the second cylinder is at the bottom dead center, the lower tire mounting hook is in a working position, and when the piston rod of the second cylinder is at the top dead center, the lower tire pressing wheel is in a working position.

10. The automatic tire changer according to claim 1, wherein a distance measurement apparatus is disposed between the column and the first demounting and mounting apparatus, and configured to detect a displacement of the first demounting and mounting apparatus relative to the column.

11. The automatic tire changer according to claim 10, wherein a distance measurement apparatus is disposed between the column and the second demounting and mounting apparatus and configured to detect a displacement of the second demounting and mounting apparatus relative to the column.

12. The automatic tire changer according to claim 11, further comprising a vertical rack securely disposed on the column, a horizontal rack disposed on the first demounting and mounting apparatus, and a horizontal rack disposed on the second demounting and mounting apparatus,
wherein the distance measurement apparatuses comprise vertical displacement potentiometers and horizontal displacement potentiometers respectively,
wherein rear ends of first potentiometer shafts of the vertical displacement potentiometers are securely provided with first distance measurement gears engaging with the vertical rack respectively, and vertical movement distances of the first demounting and mounting apparatus and the second demounting and mounting apparatus are obtained through rotation data of the first distance measurement gears respectively,
rear ends of second potentiometer shafts of the horizontal displacement potentiometers are securely provided with second distance measurement gears engaging with the horizontal racks respectively, and horizontal movement distances of the first demounting and mounting apparatus and the second demounting and mounting apparatus are obtained through rotation data of the second distance measurement gears respectively.

13. The automatic tire changer according to claim 1, wherein the control system comprises an operation console, a central processing unit (CPU) and a display device that are interconnected, wherein the operation console is provided with a key or a joystick for inputting an instruction and capable of separately controlling the tire mounting seat mechanism, the first demounting and mounting apparatus, and the second demounting and mounting apparatus to run through the key or the joystick.

14. The automatic tire changer according to claim 13, wherein the display device is a touch screen and capable of inputting an operation instruction and displaying a running state of the device.

15. The automatic tire changer according to claim 1, comprising a hydraulic separation shovel.

16. The automatic tire changer according to claim 1, comprising an auxiliary tire pressing arm.

17. A control system for an automatic tire changer, comprising:
a central processing unit (CPU) configured to receive data information, perform a comprehensive operation on the data information, and send an instruction;
an operation console electrically connected to the CPU and configured to control input of the instruction; and
a display device configured to display a program being executed and a running state of a device,
wherein the data information at least comprises rotation angle data of a tire and displacement data of a first demounting and mounting apparatus and a second demounting and mounting apparatus in horizontal and vertical directions.

18. The control system for an automatic tire changer according to claim 17, wherein the display device is a touch screen and capable of controlling the input of the instruction.

19. The control system for an automatic tire changer according to claim 18, further comprising a counter circuit board configured to collect the rotation angle data of the tire; and
distance measurement apparatuses configured to collect the displacement data of the first demounting and mounting apparatus and the second demounting and mounting apparatus in the horizontal and vertical directions respectively,
wherein the CPU is configured to comprehensively calculate the rotation angle data of the tire, and
the displacement data of the first demounting and mounting apparatus and the second demounting and mounting apparatus in the horizontal and vertical directions, and issue corresponding action instructions to a tire mounting seat mechanism, the first demounting and mounting apparatus, and the second demounting and mounting apparatus to automatically demount or mount the tire.

20. The control system for an automatic tire changer according to claim 19, wherein the displacement data of the first demounting and mounting apparatus and the second demounting and mounting apparatus in the horizontal and vertical directions is measured by potentiometers respectively.
